(19) United States
(12) Patent Application Publication
(10) Pub. No.: US 2014/0185086 A1
(43) Pub. Date: Jul. 3, 2014

(54) USING A PRINTER DRIVER PROVIDED BY A TARGET PRINTER

(71) Applicants: Michael F. Fallon, Tiverton, RI (US); Myles Wilde, Charlestown, MA (US); Matthew J. Adiletta, Bolton, MA (US)

(72) Inventors: Michael F. Fallon, Tiverton, RI (US); Myles Wilde, Charlestown, MA (US); Matthew J. Adiletta, Bolton, MA (US)

(21) Appl. No.: 13/997,068

(22) PCT Filed: Oct. 1, 2011
(86) PCT No.: PCT/US11/54493

§ 371 Date: Mar. 10, 2014

(51) Int. Cl. G06F 3/12

(52) U.S. Cl. CPC G06F 3/1225; G06F 3/1286
USPC 358/1.15

(57) ABSTRACT

Systems and methods of operating a computing system may involve providing a printer driver to a print client in order to print a document. In one example, a request to print a document is initiated, wherein it is determined that a driver for a selected printer is not installed on the print client. Upon such a determination, a driver for the target printer may be located, transmitted to the print client, and installed on the print client.

### BACKGROUND

1. Technical Field

Embodiments generally relate to providing printer drivers. More particularly, embodiments relate to utilizing a target printer to acquire a printer driver for a client device.

2. Discussion

Typically, a driver may be used to translate commands from a client device (e.g., a notebook computer) to commands understood by a target device (e.g., a printer). In order to complete a print request from client device, a printer driver may be installed on the client device. A client device user may not know, however, where to find that particular printer driver, or how to install it.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a computer system that utilizes a target printer to acquire a driver for a client device in accordance with an embodiment of the invention; and

FIG. 2 is a flowchart of an example of a method of utilizing a target printer to acquire a driver for a client device in accordance with an embodiment of the invention.

### DETAILED DESCRIPTION

Embodiments may involve a computer implemented a method for determining that a driver for a target printer is not installed on a print client, transmitting a request communication to the target printer to locate a driver for the target printer, and locating the driver for the target printer. The method may also provide for acquiring the driver for the target printer and transmitting a return communication including the driver for the target printer to the print client.

Embodiments can also involve a computer readable storage medium including a set of print client instructions, which, if executed by a processor, cause a computer to determine that a driver for a target printer is not installed on a print client and transmit a request communication to the target printer to locate the driver for the target printer. The instructions may also cause a computer to receive a response communication including the driver for the target printer.

In addition, embodiments may include a computer readable storage medium including a set of target printer instructions, which, if executed by a processor, cause a computer to receive a request communication from a print client to locate a driver for the target printer, locate the driver for the target printer, acquire the driver for the target printer, and transmit a return communication including the driver for the target printer to the print client. The instructions may also cause a computer to receive a print request communication including a file to print.

Other embodiments can involve a system including a client processing component, a client memory device including a client-side driver requesting application having a set of instructions for execution by the client processing component, a printer processing component, and a processor memory device including a printer-side driver providing application having a set of instructions for execution by the printer processing component. At least one of the client-side driver requesting application and the printer-side driver providing application may be configured to determine that the driver for the target printer is not installed on the print client, transfer a request communication to the target printer to locate the driver for the target printer, locate the driver for the target printer, and acquire the driver for the target printer. At least one of the client-side driver requesting application and the printer-side driver providing application may also be configured to transfer a return communication including the driver for the target printer to the print client and install the driver for the target printer on the print client.

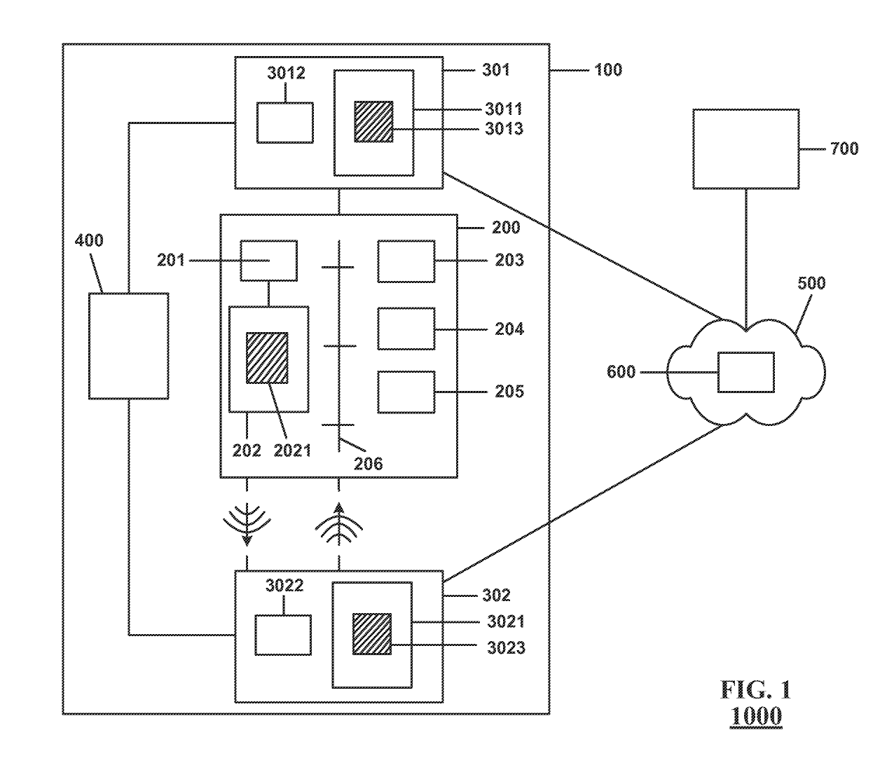

Turning now to FIG. 1, a block diagram of a computing system 1000 is shown in which a printer driver is provided to a print client device. A client network 100 may be a personal area network (PAN), local area network (LAN), wireless network, wide area network (WAN), storage area network (SAN), virtual private network (VPN) or any similar collection of interconnected computer devices that facilitate communication and transmit among the interconnected computer devices. In the embodiment illustrated in FIG. 1, the client network 100 is a LAN. The client network 100 may include a print client 200, printers 301, 302, and a network database 400, wherein the client network 100 may be coupled to the Internet 500 and an OEM (Original Equipment Manufacturer) database 700.

The print client 200 may be any electronic device capable of directing a print request. For example, the print client 200 may be a mobile device (e.g., a mobile/smart phone, a personal digital assistant, a tablet device), a laptop/notebook computer, or a desktop computer. In the embodiment illustrated. in FIG. 1, the print client 200 may be a notebook computer.

As will be discussed in greater detail, in certain embodiments of the present invention, the operating system (OS) of the print client 200 may support a print functionality, while in other embodiments the OS may not. In the embodiment illustrated in FIG. 1, the print client 200 may utilize a Windows OS that may support a print functionality.

The print client 200 may include a client processing component 201, a client storage device 202, a print client interface 203, a client I/O device 204, a client wireless transceiver 205, and a client bus 206. The client processing component 201 may include at least one computer processor that may be utilized to execute computer-readable executable instructions.

The client storage device 202 may be a memory device that may be used to store data. The client storage device 202 may be built into the print client 200, or may be a removable peripheral storage device coupled to the print client 200. The client storage device 202 may store applications including computer-readable executable instructions that may be executed by a processing component (e.g., client processing component 201). More specifically, the client storage device 202 may store a client-side driver requesting application 2021 that may be executed to implement a method for utilizing a target printer to acquire a driver for a client device.

The print client 200 may also include the client display interface 203. in this embodiment, the print client interface 203 may be a notebook display screen displaying a graphical user interface (GUI)—based Internet browser. In addition, the print client 200 may include any the client input/output (I/O) device 204 (e.g., a mouse, a keyboard) that enables a user to input data or instructions to print client 100. In this embodiment, the client I/O device 204 may be a built-in keyboard located on the print client 100.

The client wireless transceiver 205 may be a transmitter/receiver that may enable the print client 200 to wirelessly communicate with other wirelessly-capable devices. In this embodiment, the print client 200 utilizes client wireless transceiver 205 to communicate with other devices (e.g., printer 302) according to a wireless Bluetooth (e.g., IEEE 802.15.1-2005, Wireless Personal Area Networks) protocol. Accordingly, the print client 200 may utilize a Bluetooth “bonding” algorithm by which one device may detect a presence of another, and engage in a “pairing” method wherein both confirm each other's identities before forming a communication path over which data is transmitted between the two devices. In other embodiments of the present invention, the client wireless transceiver 205 may enable the print client 100 to communicate according to other wireless communication protocols (e.g., near-field communication, Wi-Fi (IEEE 802.11, Wireless Personal Area Networks)). The client bus 206 may be utilized to transmit data between various components of print client 200.

The printers 301, 302 may include any device coupled to the print client 200 capable of receiving a print request and executing it. In this embodiment, the printer 301 utilizes a hardwired communication technology to communicate with the print client 200, while the printer 302 utilizes a wireless communication technology. Specifically, the printer 302 may utilize a printer transceiver 3024 to communicate wirelessly according to various communication protocols (e.g., near-field communication, Wi-Fi, Bluetooth) with the print client 200. In this embodiment, the printer 302 may utilize a Bluetooth protocol to communicate with the print client 200.

The printers 301, 302 may include printer processing components 3012, 3022, wherein the printer processing components 3012, 3022 may include at least one computer processor that may be utilized to execute computer-readable executable instructions. The printers 301, 302 may also include printer storage devices 3011, 3021, respectively, that may store data. For example, the printer storage devices 3011, 3021 may be utilized to store various applications including computer-readable executable instructions that may be executed by the printer processing components 3012, 3022. For example, the printer storage devices 3011, 3021 may be utilized to store various printer drivers. In addition, as will be discussed in greater detail below, the printer storage devices 3011, 3021 may also store the printer-side driver providing applications 3013, 3023 that may be executed to implement a method for utilizing a target printer to acquire a driver for a client device.

The illustrated printers 301, 302 are coupled to a network database 400. The network database 400 may be a database that services a network including the print client 200, and may store applications such as various printer drivers. The printers 301, 302 may also be coupled to a network such as the Internet 500. The Internet 500 may be used to access a printer driver (such as that of printers 301, 302) from a website 600 of an Original Equipment Manufacturer (OEM). Internet 500 may also be utilized to access OEM database 700. The OEM database 700 may include a memory device 701 to store various applications including printer drivers for the printers 301, 302. In certain embodiments of the present invention, the website 600 and the OEM database 700 may be part of a cloud service, wherein the cloud service may be accessed to provide a driver as described herein.

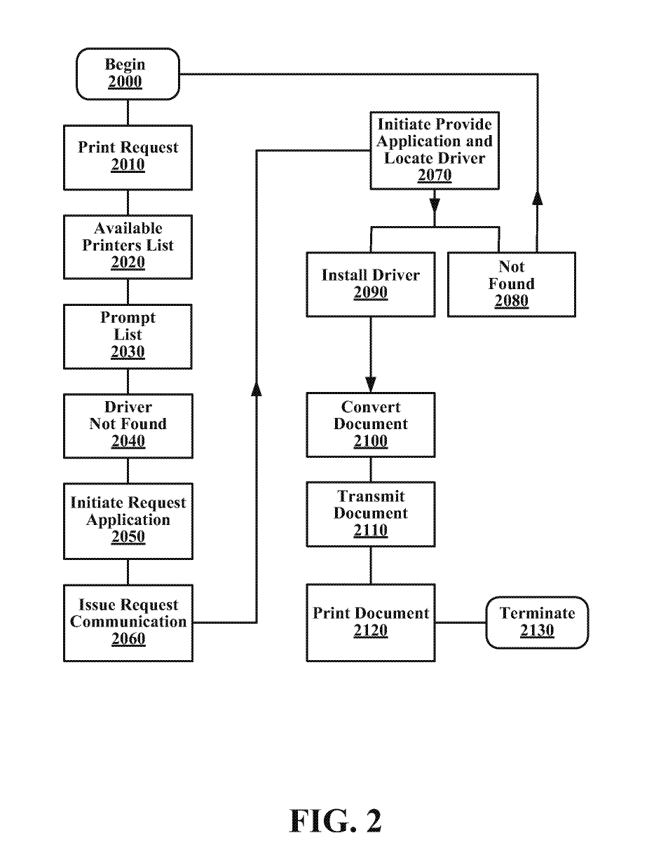

Turning now to FIG. 2, a flowchart of an exemplary method of utilizing a target printer to acquire a driver for a client device according to one embodiment of the present invention is shown. The method might be implemented as a set of logic instructions stored in a machine- or computer-readable storage medium such as random access memory (RAW, read only memory (ROM), programmable ROM (PROM), firmware, flash memory, etc., in configurable logic such as programmable logic arrays (PLAs), field programmable gate arrays (FPGAs), complex programmable logic devices (CPLDs), in fixed-functionality logic hardware using circuit technology such as application specific integrated circuit (ASIC), complementary metal oxide semiconductor (CMOS) or transistor-transistor logic (TTL) technology, or any combination thereof. For example, computer program code to carry out operations shown in the method may be written in any combination of one or more programming languages, including an object oriented programming language such as Java, Smalltalk, C++ or the like and conventional procedural programming languages, such as the “C” programming language or similar programming languages.

In this embodiment, a user may utilize a print client, such as the print client 200 (FIG. 1), already discussed, that executes a Windows OS and is located within a network, such as the LAN 100 (FIG. 1), already discussed, to direct a document print request to a target printer, such as the target printer 302 (FIG. 1) discussed above. Furthermore, in this embodiment, the Windows OS of the print client may support a printing functionality.

The illustrated method begins at processing block 2000. At processing block 2010, the user may initiate a print request to print a document through a print client GUI interface, such as the client interface 203 (FIG. 1) discussed above. At processing block 2020, the print client OS, initiating the printing functionality, may search for available printers, and generate a list. At processing block 2030, the print client OS may present the user with the list of available printers, and provide a prompt to select the target printer. In this embodiment, the print client and the target printer may communicate wirelessly via a Bluetooth protocol.

After selection of a target printer, at processing block 2040, the print client OS may recognize that the driver for the target printer is not installed on the print client. At processing block 2050, responsive to this recognition, the print client OS may initiate a client-side driver requesting application, such as client-side driver requesting application 2021 (FIG. 1) discussed above. At processing block 2060, the client-side driver requesting application may issue a request communication to the target printer to locate a printer driver for the target printer, wherein the request communication may include relevant characteristics of the print client (e.g., OS type, CPU type) to aid the target printer in securing the driver.

At processing block 2070, responsive to receiving the request communication, the target printer may initiate a printer-side driver providing application, such as the printer-side driver providing application 3013 (FIG. 1) already discussed, to locate and forward a printer driver to the print client. That is, the printer-side driver providing application may utilize the relevant characteristics of the print client included in the request communication, along with other relevant information (e.g., target printer model name) to search for, locate, and acquire a printer driver for the print client. As discussed above, the printer-side driver providing application may search for the driver at a printer memory device, such as printer memory device 2011 (FIG. 1) already discussed, a network database such as network database 300 (FIG. 1) already discussed, on a website located on the Internet such as Internet 400 (FIG. 1) already discussed, or an OEM database, such as OEM database 500 (FIG. 1) discussed above, among other places, In this embodiment, the printer-side driver providing application may locate the driver at a printer memory device, and transmit a return communication including the printer driver to the print client.

If no printer driver is found, the printer-side driver providing application may transmit a message to the print client that the print request cannot be completed (at processing block 2080), and the process returns to processing block 2000. At processing block 2090, upon receiving the return communication including the printer driver, the client-side driver requesting application may associate the provided driver with the selected printer and install the driver according to an appropriate print client configuration.

At processing block 2100, the print client OS may return to completing the print request. Specifically, the print client OS may convert the document from the user application format to the OS format, and the retrieved driver may convert the document front the OS format to the target printer format. At processing block 2110, the print client may transmit the document in the target printer format for printing. At processing block 2120, the target printer may process the print request and may print the document. At processing block 2130, the process may terminate.

It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense. For example, as discussed above, embodiments of the present invention may extend to a print client operating an OS that may not natively support a printing functionality (e.g., mobile phones, tablet devices). In these cases, embodiments of the present invention may be implemented in conjunction with a printing application.

A printing application may be utilized to, among other things, identify the file to print and identify the target printer. In certain embodiments, after implementing the printing application, the client OS may recognize that a driver for the target printer is not installed, and a client-side driver requesting application may be initiated to issue a request communication to search for, locate, and acquire a printer driver for the target printer,

In addition, in various embodiments of the present invention, the client-side driver requesting application and the printer-side driver providing application may be initiated at different points in the process. For example, in the example described above, the client-side driver requesting application may be initiated upon the recognition that the driver for the target printer is not installed on the client device. In other embodiments, however, the client-side driver requesting application may be initiated after a user initiates a print request at the print client. Similarly, in the example described above, the printer-side driver providing application may be initiated upon receiving a request communication from the client-side driver requesting application. However, in other embodiments, the print client and the target printer may be configured so that the printer-side driver providing application may be initiated upon the recognition that the driver for the target printer is not installed on the client device.

Furthermore, in embodiments of the present invention, the print client user may be completely unaware, partially aware, or fully aware of the progress of the print request. For example, in certain embodiments, the print client user may be completely unaware of the process that determines a printer driver for a target printer is necessary, and searches for, locates, retrieves, and installs the driver. Effectively, in these embodiments, the user may direct the print client to “print” and the document is printed, during which a printer driver providing process as described above is implemented in full completely unbeknownst to the user. In other embodiments, the progress of a printer driver providing process may be indicated by a description (e.g., “acquiring printer driver”, “installing printer driver”), or by an hourglass image to indicate processing.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

In addition, in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding. Any represented signal lines, whether or not having additional information, may actually include one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details are set forth in order to describe example embodiments of the invention, it should be apparent to one skilled in the art that embodiments of the invention can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. are used herein only to facilitate discussion, and carry no particular temporal or chronological significance unless otherwise indicated.

The terms “update” or “upgrade” may be used herein to refer to any type of installing, securing, or providing an application (e.g., a printer driver) to replace another application, including replacing a current version of the application with a newer or alternate one.

Several features and aspects of embodiments of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

We claim:

1. A method comprising:
determining that a driver for a target printer is not installed on a print client;
transmitting a request communication to the target printer to locate the driver for the target printer;
locating the driver for the target printer;
acquiring the driver for the target printer; and
transmitting a return communication including the driver for the target printer to the print client.

2. The method of claim 1, wherein a client-side driver requesting application Is transmits the request communication.

3. The method of claim 2, wherein the client-side driver requesting application associates the driver received in the return communication with the target printer and installs the driver according to a print client configuration.

4. The method of claim 1, wherein a printer-side driver providing application locates and acquires the driver for the target printer.

5. The method claim 4, wherein the printer-side driver providing application searches at least one of a printer memory device, a network database, a website, and an OEM database for the driver.

6. The method of claim 1, wherein a printing application identifies a file to print and the target printer if an operating system of the print client does not support a printing functionality.

7. A computer readable storage medium comprising a set of print client instructions, which, if executed by a processor, cause a computer to:
determine that a driver for a target printer is not installed on a print client;
transmit a request communication to the target printer to locate the driver for the target printer; and
receive a response communication including the driver for the target printer.

8. The medium of claim 7, wherein a client-side driver requesting application is to transmit the request communication.

9. The medium of claim 8, wherein the client-side driver requesting application is to associate the driver received in the return communication with the target printer and install the driver according to an appropriate print client configuration.

10. The medium of claim 7, wherein the response communication is to be received from a printer-side driver providing application.

11. The medium of claim 10, wherein the printer-side driver providing application is to locate and acquire the driver for the target printer.

12. The medium claim 11, wherein the printer-side driver providing application is to search for the driver in at least one of a printer memory device, a network database, a website, and an OEM database.

13. The medium of claim 7, wherein a printing application is to identify a file to print and the target printer if an operating system of the print client does not support a printing functionality.

14. A computer readable storage medium comprising a set of target printer instructions, which, if executed by a processor, cause a computer to:
receive a request communication from a print client to locate a driver for the target printer;
locate the driver for the target printer;
acquire the driver for the target printer;
transmit a return communication including the driver for the target printer to the print client; and
receive a print request communication including a file to print.

15. The medium of claim 14, wherein the request communication is to be received from a client-side driver requesting application.

16. The medium of claim 15, wherein the client-side driver requesting application is to associate the driver received in the return communication with the target printer and install the driver according to a print client configuration.

17. The medium of claim 14, wherein a printer-side driver providing application is to transmit the return communication including the driver for the target printer to the print client.

18. The medium of claim 17, wherein the printer-side driver providing application is to locate and acquire the driver for the target printer.

19. The medium claim 17, wherein the printer-side driver providing application is to search for the driver in at least one of a printer memory device, a network database, a website, and an OEM database.

20. The medium of claim 17, wherein a printing application is to identify a file to print and the target printer if an operating system of the print client does not support a printing functionality.

21. A system comprising:
a client processing component;
a client memory device including a client-side driver requesting application having a set of instructions to be executed by the client processing component;
a printer processing component; and
a processor memory device including a printer-side driver providing application having a set of instructions to be executed by the printer processing component,
wherein at least one of the client-side driver requesting application and the printer-side driver providing application arc configured to:
determine that a driver for the target printer is not installed on the print client;
transfer a request communication to the target printer to locate the driver for the target printer;
locate the driver for the target printer;
acquire the driver for the target printer;
transfer a return communication including the driver for the target minter to the print client; and
install the driver for the target printer on the print client.

22. The system of claim 21, wherein a client-side driver requesting application is to transmit the request communication.

23. The system of claim 21, wherein the client-side driver requesting application is to associate the driver received in the return communication with the target printer and install the driver according to a print client configuration.

24. The system of claim 21, wherein the printer-side driver providing application is to transmit the return communication including the driver for the target printer to the print client.

25. The system of claim 21, wherein the printer-side driver providing application is to locate and acquire the driver for the target printer.

26. The system claim 21, wherein the printer-side driver providing application is to search for the driver in at least one of a printer memory device, a network database, a website, and an OEM database.

27. The system of claim 21, wherein a printing application is to identify a file to print and the target printer if an operating system of the print client does not support a printing functionality.
